(19) United States
(12) Patent Application Publication
(10) Pub. No.: US 2005/0160102 A1
(43) Pub. Date: Jul. 21, 2005

(54) Look-ahead predicate generation for join costing and optimization

(75) Inventors: Abdo Esmail Abdo, Rochester, MN (US); Robert Joseph Bestgen, Dodge Center, MN (US); John David Dietel, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/758,485

(22) Filed: Jan. 15, 2004

(51) Int. Cl. G06F 7/00

(52) U.S. Cl. 707/100

(57) ABSTRACT

A relational database system analyzes each potential join in a query, to determine whether a relation involved in the join is subject to a selection criterion, and evaluate whether that selection criterion or the join per se effects a join reduction. The computational expense of generating a look-ahead predicate comprising the tuples of the second relation matching any applicable selection criterion, is compared to the computational savings that result from the join reduction. The most beneficial look-ahead predicate among all potential joins of relations in the query is identified through iterative analysis of all possible joins. Thereafter, membership in the look-ahead predicate is added as a selection criterion on the first relation, and further iterative analysis is performed of all possible joins of the remaining relations and the look-ahead predicate, to iteratively identify additional joins in the query that benefit from the formation of the look-ahead predicate, and potentially form further look-ahead predicates.

### FIELD OF THE INVENTION

The present invention relates to generation of join query results in the management and execution of relational database queries.

### BACKGROUND OF THE INVENTION

Relational Database Management System (RDBMS) software using a Structured Query Language (SQL) interface is well known in the art. The SQL interface has evolved into a standard language for RDBMS software and has been adopted as such by both the American Nationals Standard Organization (ANSI) and the International Standards Organization (ISO).

In RDBMS software, all data is externally structured into relations, each relation dealing with one or more attributes and comprising one or more tuples of data, each tuple associating attribute values with each other. A relation can be visualized as a table, having rows and columns (indeed, the relations in a particular database are often referred to as the “tables” of the database). When a relation is visualized as a table, the columns of the table represent attributes of the relation, and the rows of the table represent individual tuples or records that are stored using those attributes. To aid in visualizing relations in this manner, in the following, the relations in an RDBMS system will frequently be referred to as that system's “tables”.

An RDBMS system may be used to store and manipulate a wide variety of data. For example, consider a RDBMS system for storing and manipulating sales information for a chain of store. In such a system, a “Sales” table storing sales information might have a first column “Date” for the date of a sale, a second column “SKU” for the inventory control number for the item sold, and a third column “Store” for the name of the store where the sale was made. Each row in the table would identify these attributes, and others, for each sale made in a store in the chain.

Often, columns in different tables are related. Thus, in the above example, the SKU identified in the “Sales” table might be used to find detailed information about the product sold in a second, “SKU” table. (In such a relationship, the SKU is known as a “foreign key” in the Sales table, because it is a lookup key for information in the SKU table.) The SKU table provides details for the product identified by the SKU, e.g., a text name for the product, the name of the vendor of the product and the vendor's address. Similarly, the store identified in the Store table may be identified by an ID number, and a “Stores” table may be used to provide detailed information about the store, such as the name, address, and geographic region of the store.

The example described so far has come to be known as a “star schema” database, common to business intelligence applications. FIG. 1A illustrates in general the layout of the foreign key links between tables in a star schema database. A central table 10 (in the example, the Sales table), known as a “fact table” conveys basic facts of interest to the architect of the database, in this case, the Sales made. Details regarding those facts are provided by other tables, known as “dimension tables”, linked to the fact table through foreign keys. In this example, the SKU table 12 and Stores table 14 are linked by foreign keys. FIG. 1B illustrates representative content of the Sales, SKUs and Stores tables 10, 12 and 14 discussed in the above examples.

As will be appreciated, in may business intelligence applications, the fact table can become extremely large. For example, a fact table in which each row (tuple) represents a sale of a single item at a single store of a large national chain, will quickly grow to billions of rows and terabytes of data. Because of the structure of the database, queries will frequently involve the fact table in a join with other of the tables. For example, a query seeking the total sales figures for a product matching a text search string (including wildcards) in the New England region, would involve a join of the SKU table, Sales table and Stores tables. The join of the SKU table would be necessitated to find those SKU's that match the identified text string; the join of the Stores table would be necessitated to find the stores in the New England region.

The challenge inherent in such queries is that the conventional online transaction processing (OLTP) implementation of the join operations, would treat the Sales table as the inner table of one or both of the joins; that is, for example, the join of the SKU table and Sales table would be performed by reviewing each row (tuple) in the SKU table, and for each matching SKU, reviewing the entire Sales table for matching sales. Because the outer loop of this process involves review of the SKU table, whereas the inner loop involves review(s) of the Sales table, the SKU table is known as the outer table and the Sales table is known as the inner table. It can be seen that this table join process with the Sales table used as the inner table, will involve repeated review of the Sales table, once for each matching SKU in the SKU table. Where the Sales table expands to the terabyte size mentioned above, this conventional OLTP methodology becomes extremely inefficient.

To confront this inefficiency, it has been proposed to utilize a “starjoin” methodology in business intelligence applications. For example, U.S. Pat. No. 6,105,020, assigned to the assignee of the present application, and incorporated herein by reference, describes a methodology for attempting to identify a fact table and dimension or “snowflake” tables, for the purpose of applying a unique “star join” method to those tables instead of conventional OLTP methods in which the fact table would likely be used as the inner table. In summary, “star join” methods involve developing, from the dimension tables, an intermediate result of all tuples matching the selection criterion operative on the dimension table, and then comparing all of these tuples to tuples in the fact table at the same time, so that only one pass need be made through the fact table. Thus, membership in the intermediate result is used as a selection predicate for the tuples in the fact table during a single pass through the fact table. Since this selection predicate is based upon the advance processing of a selection criterion from the dimension table, it may be referred to as a “look-ahead predicate”.

Unfortunately, known methods cannot reliably identify many situations where a “star join” method should be substituted for a conventional inner/outer join, for the reason that business intelligence database schema often do not follow a conventional star pattern. Rather, in some instances the schema for a business intelligence database has a more complex, “snowflake” pattern such as is shown in FIG. 2A.

Snowflake pattern databases frequently arise when normalization practices are used on the dimension tables of a database. For example, as seen in FIG. 2B, the dimension table 12 for SKUs has been normalized into two tables 12a and 12b, by separating vendor identification information and SKU information; the SKU table 12a includes the name of a product under a SKU, and an identifier for the product vendor, which is a foreign key to a Vendors table 12b which identifies the name and address of the vendor. Similarly, the dimension table 14 for Stores has been normalized into three tables 14a, 14b and 14c, by separating store regional information and store information; the Store table 14a includes the name of a store and identifiers for the store region and store type, which are foreign keys to a Regions table 14b that identifies a region and a Types table 14c that identifies types of stores.

The key difficulty with databases having a “snowflake” or other complex schema is that techniques used to determine when to use a star join and when to use a conventional inner/outer join, are specialized and are applicable only to schema that fit a specific typical or expected schema.

Accordingly, there is a need for a method for identifying when a query may be more efficiently implemented with nonconventional join techniques in more diverse circumstances than has previously been the case.

### SUMMARY OF THE INVENTION

In accordance with principles of the present invention, these needs are met by a process for systematically evaluating join predicates in a query to determine the selectivity in a first relation in the join, as a consequence of the join, and/or any selection predicates operative upon the second relation in the join.

In specific embodiments in accord with principles of the present invention, a relational database system analyzes each potential join in a query, to determine whether a relation involved in the join is subject to a selection criterion, and evaluate whether the join per se, or the join after application of the selection criterion, effects a join reduction. In the described embodiment, the amount of join reduction is determined by identifying whether the number of rows in the join result produced will be smaller than the number of rows from second relation, although join reduction can be identified with other criteria.

Upon identifying a potential join reduction involving a first and a second relation, and any selection criterion on the second relation, the potential benefit of that join reduction is assessed. Specifically, the relational database system evaluates the computational expense of generating a look-ahead predicate comprising the tuples of the second relation that match any selection criterion, and this expense is compared to the computational savings that result from the join reduction. In the event the formation of the look-ahead predicate is beneficial, processing of the query forms and utilizes the look-ahead in the join of the first and second relations.

In the described specific embodiment, the most beneficial look-ahead predicate among all potential joins of relations in the query is identified through iterative analysis of all possible joins. Thereafter, membership in a look-ahead predicate is added as a selection criterion on the first relation, and further iterative analysis is performed of all possible joins of the remaining relations and the look-ahead predicate. This process thus finds additional joins in the query that benefit from the formation of the look-ahead predicate.

These and other features and advantages, which characterize the invention, are set forth in the claims annexed hereto and forming a further part hereof. However, for a better understanding of the invention, and of the advantages and objectives attained through its use, reference should be made to the Drawing, and to the accompanying descriptive matter, in which there is described exemplary embodiments of the invention.

### BRIEF DESCRIPTION OF THE DRAWING

FIG. 1A is an abstract schema diagram for a star schema database having a fact table and dimension tables, and FIG. 1B is a schema diagram showing Sales, SKUs and Stores tables in such a database;

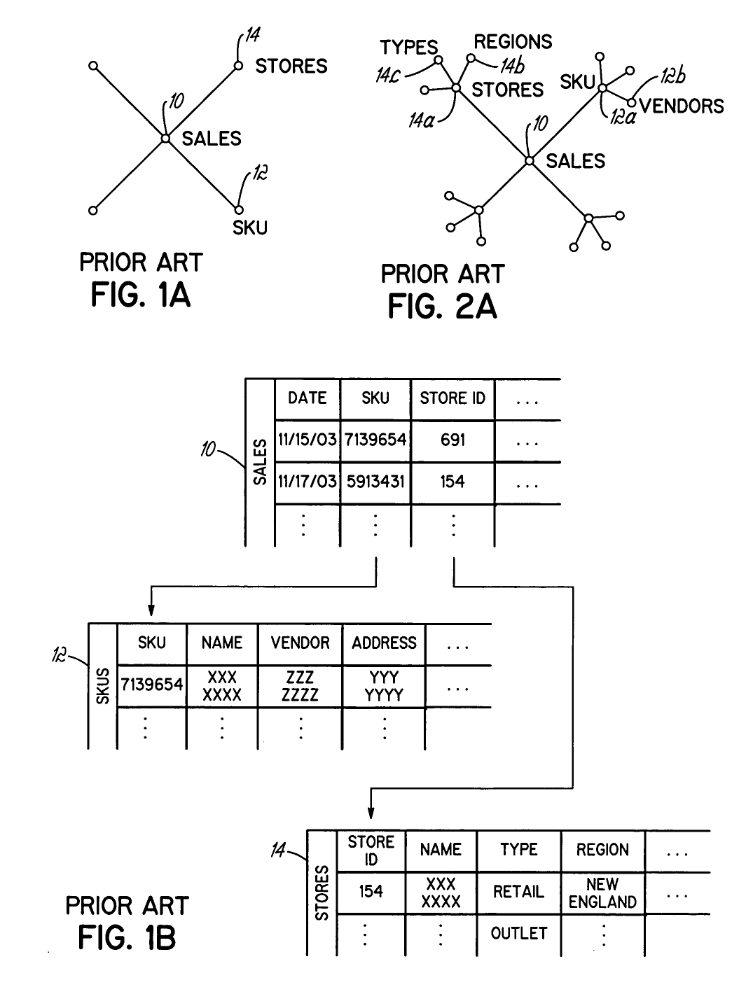

FIG. 2A is an abstract schema diagram for a snowflake schema database having a fact table and dimension tables, and FIG. 2B is a schema diagram showing Sales, SKUs, Vendors, Stores, Regions and Managers tables in such a database;

FIG. 3 is a block diagram of an apparatus according to an embodiment of the present invention; and

FIG. 4 is a flow diagram of a process for evaluating a query to identify beneficial look-ahead predicates in an iterative fashion.

### DETAILED DESCRIPTION

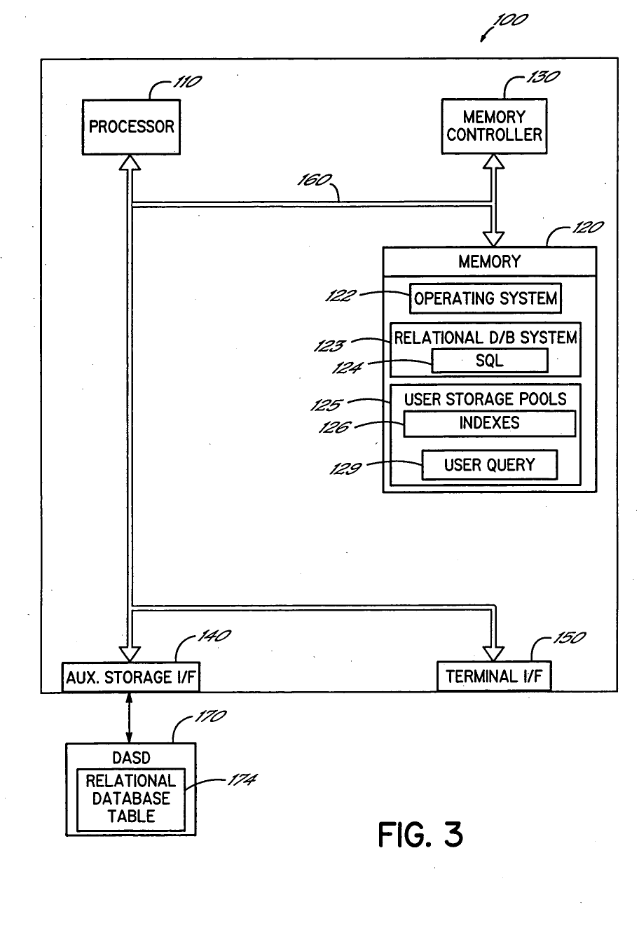

The methods of the present invention employ computer-implemented routines to query information from a database. Referring now to FIG. 3, a block diagram of a computer system which can implement an embodiment of the present invention is shown. The computer system shown in FIG. 3 has a particular configuration; however, those skilled in the art will appreciate that the method and apparatus of the present invention apply equally to any computer system, regardless of whether the computer system is a complicated multi-user computing apparatus or a single user device such as a personal computer or workstation. Thus, computer system 100 can comprise other types of computers such as IBM compatible personal computers running OS/2 or Microsoft's Windows. Computer system 100 suitably comprises a processor 110, main memory 120, a memory controller 130, an auxiliary storage interface 140, and a terminal interface 150, all of which are interconnected via a system bus 160. Note that various modifications, additions, or deletions may be made to computer system 100 illustrated in FIG. 3 within the scope of the present invention such as the addition of cache memory or other peripheral devices. FIG. 3 is presented to simply illustrate some of the salient features of an exemplary computer system 100.

Processor 110 performs computation and control functions of computer system 100, and comprises a suitable central processing unit (CPU). Processor 110 may comprise a single integrated circuit, such as a microprocessor, or may comprise any suitable number of integrated circuit devices and/or circuit boards working in cooperation to accomplish the functions of a processor. Processor 110 suitably executes a computer program within main memory 120.

Auxiliary storage interface 140 allows computer system 100 to store and retrieve information such as relational database table or relation 174 from auxiliary storage devices, such as magnetic disk (e.g., hard disks or floppy diskettes) or optical storage devices (e.g., CD-ROM). As shown in FIG. 3, one suitable storage device is a direct access storage device (DASD) 170. DASD 170 may alternatively be a floppy disk drive which may read programs and data such as relational database table 174 from a floppy disk. In this application, the term “disk” will be used to collectively refer to all types of storage devices, including disk drives, optical drives, tape drives, etc. It is important to note that while the present invention has been (and will continue to be) described in the context of a fully functional computer system, those skilled in the art will appreciate that the mechanisms of the present invention are capable of being distributed as a program product in a variety of forms, and that the present invention applies equally regardless of the particular type of signal bearing media to actually carry out the distribution. Examples of signal bearing media include: recordable type media such as floppy disks (e.g., a floppy disk) and CD ROMS, and transmission type media such as digital and analog communication links, including wireless communication links.

Memory controller 130, through use of a processor is responsible for moving requested information from main memory 120 and/or through auxiliary storage interface 140 to processor 110. While for the purposes of explanation, memory controller 130 is shown as a separate entity, those skilled in the art understand that, in practice, portions of the function provided by memory controller 130 may actually reside in the circuitry associated with processor 110, main memory 120, and/or auxiliary storage interface 140.

Terminal interface 150 allows system administrators and computer programmers to communicate with computer system 100, normally through programmable workstations. Although the system 100 depicted in FIG. 3 contains only a single main processor 110 and a single system bus 160, it should be understood that the present invention applies equally to computer systems having multiple buses. Similarly, although the system bus 160 of the embodiment is a typical hardwired, multidrop bus, any connection means that supports-directional communication in a computer-related environment could be used.

In the illustrated embodiment, memory 120 suitably includes an operating system 122, a relational database system 123, and user storage pools 125. Relational database system 123 includes structured query language (SQL) 124, which is an interactive query and report writing interface. Those skilled in the art will realize that SQL 124 could reside independent of relational database system 123, in a separate memory location.

User storage pools 125 include indexes 126 such as that illustrated in FIG. 3, as well as storage for temporary data such as a user query 129. User query 129 is a request for information from relational database table 174 stored in DASD 170. The methods of the present invention do not require that the entire relational database table be loaded into memory 120 to obtain the information requested in user query 129. Instead, indexes are loaded into memory 120 and provide relational database system 123 an efficient way to obtain the information requested by user query 129.

It should be understood that for purposes of this application, memory 120 is used in its broadest sense, and can include Dynamic Random Access Memory (DRAM), Static RAM (SRAM), flash memory, cache memory, etc. Additionally, memory 120 can comprise a portion of a disk drive used as a swap file. While not explicitly shown in FIG. 3, memory 120 may be a single type of memory component or may be composed of many different types of memory components. For example, memory 120 and CPU 110 may be distributed across several different computers that collectively comprise system 100. It should also be understood that programs in memory 120 can include any and all forms of computer programs, including source code, intermediate code, machine code, and any other representation of a computer program.

Users of relational database system 123 provide requests for information in a useful form by creating user query 129. User query 129 is a way to ask relational database system 123 to provide only the set of information from relational database table 174 that meets certain criteria. Structured Query Language (SQL) 124 is the standard command language used to query relational databases. SQL commands are entered by a user to create user query 129, which then typically undergoes the following front-end processing by relational database system 123. User query 129 is parsed for syntax errors. The relational database table from where the user wants his information is identified. The field name(s) associated with the information are verified to exist in the relational database table. And, the SQL commands in user query 129 are reviewed by optimization software in relational database system 123 to determine the most efficient manner in which to process the user's request.

The front-end optimization processing of user query 129 by relational database system 123 determines whether a particular index 127 exists that can facilitate scanning for requested data more efficiently than another database index or than the relational database housed in DASD 170. In order for an index to be useful to the methods of the present invention, the index must be built over the database fields specified by the criteria in user query 129. That is, there must be an index for those particular fields in that particular database.

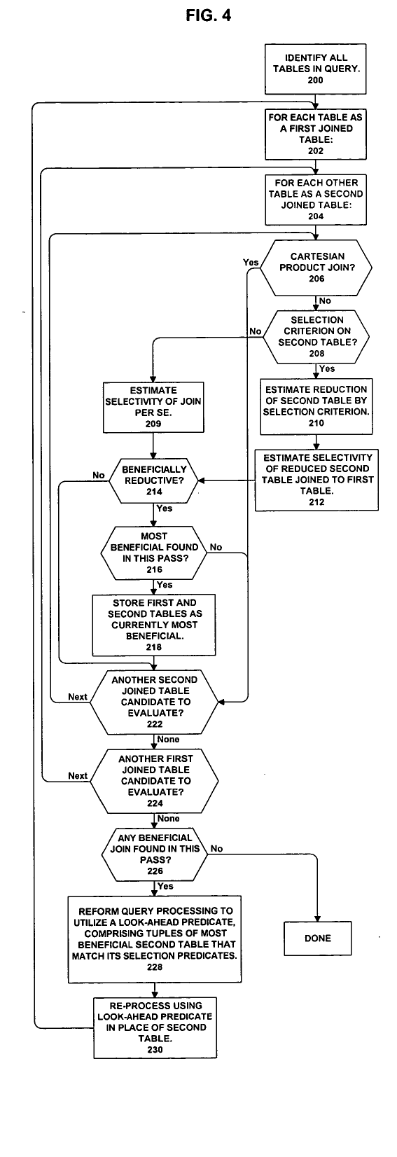

Referring now to FIG. 4, a process for evaluating a query for beneficial join operations can be described. In a first step 200, all tables referenced in the query are identified. Then, in an iterative process, the potential join of each table with each other table is evaluated for potentially beneficial use of a look-ahead predicate.

Specifically, for each table in the query as a candidate first joined table (step 202), and for each other table in the query as a candidate second joined table (step 204), the potential join of the tables is evaluated, to determine whether the join is reductive on the first table. In many cases, the tables will have no joinable columns or no join criterion in the query, and will therefore form a Cartesian product join, which is clearly not reductive. For this reason, in step 206 the join is evaluated to determine whether it will be a Cartesian product join.

In the event the candidate first and second tables have joinable columns, and thus will not form a Cartesian product join, processing continues through step 206 to step 208 in which it is determined whether there is a selection criterion in the query that is operative on the candidate second table. If so, then the effect of this selection criterion on the join is evaluated in step 210. Specifically, indexes available for the database are used to estimate the size of the result set produced by the selection criterion from the query. The use of indexes to form such estimates is well known and frequently utilized in relational database processing, and so will not be explored at length here. After forming such an estimate, in step 212, an estimate is made of the selectivity of the join of the thus-reduced second table to the first table. For example, indexes may be used in determining, as one example, a count of the unique values that are likely to remain in the joined column of the second table after application of the selection criterion on the second table, and a count of the unique values in the joined column of the first table, which can be used together to estimate the likely number of matching tuples in the first table after the application of the selection criterion in the second table.

In the event the candidate second table does not have a selection criterion, in step 209, the selectivity of the join of the two tables, per se, is evaluated for selectivity. It will be appreciated that databases frequently are constructed without referential integrity between tables. For example, a table may be formed that has only special cases applicable to a handful of values of a foreign key in another table. In such an instance, a join of the tables with a join predicate on the foreign key, will be reductive regardless of the existence of any selection criterion on either table. Accordingly, even in the absence of a selection criterion, the join per se is assessed for selectivity.

In step 214, it is determined whether the join with the candidate second table (including the use of any selection criterion on the candidate second table), based on the computed estimates, will be beneficially reductive. Specifically, the computational cost of forming a look-ahead predicate for a join of the first and second tables, is compared to the computational benefit of avoiding the inefficiencies of a conventional inner-outer join operation. The details of this evaluation may turn on a few or a large number of factors, such as the relative size of the relations in the database, the number of unique values remaining in the look-ahead predicate, and others.

If, in step 214, the formation of a look-ahead predicate for the current candidate join is deemed beneficial, in step 216 a measure of the resulting benefit is compared to the same measures formed for any other candidate join deemed beneficial during the current iteration of the main loop that begins at step 202. If the current candidate is the most beneficial join, in step 218 the candidate first and second tables and the measures generated from them are stored as the currently most beneficial candidate join for look-ahead predicate generation.

After step 218, or immediately after steps 216, 214 or 206 in the event a candidate join is not deemed beneficial or the most beneficial, processing continues to step 222, where it is determined whether there is another candidate second table to evaluate. If so, then processing returns to step 206 to determine whether the new candidate second joined table has a potentially reductive join with the candidate first joined table.

After every candidate second joined table has been evaluated in the loop of steps from 204 through 222, in step 224 it is determined whether there is another candidate first table to evaluate. If so, then processing returns to step 204 to begin the process of evaluating candidate joins of the new candidate first table with each other table in the loop of steps from 204 to 222.

Once all candidate first tables have been evaluated with all candidate second tables, processing continues from step 224 to step 226, in which it is determined whether any beneficial candidate joins were identified in the current pass through the main loop of steps from 202 through 224. If so, then in step 228, the query processing is reformed to utilize a look-ahead predicate, which is formed from the tuples of the second table of the most beneficial join, that match any selection criterion of the second table. Thereafter, commencing in step 230, the loop of steps beginning at step 202 is restarted, to re-evaluate possible joins in the event that the look-ahead predicate has made other joins more beneficial.

Through this iterative process, it is likely that multiple, sequential look-ahead predicates may be identified, resulting in a beneficial sequencing of look-ahead predicates through joins that dramatically reduces processing expense of a query.

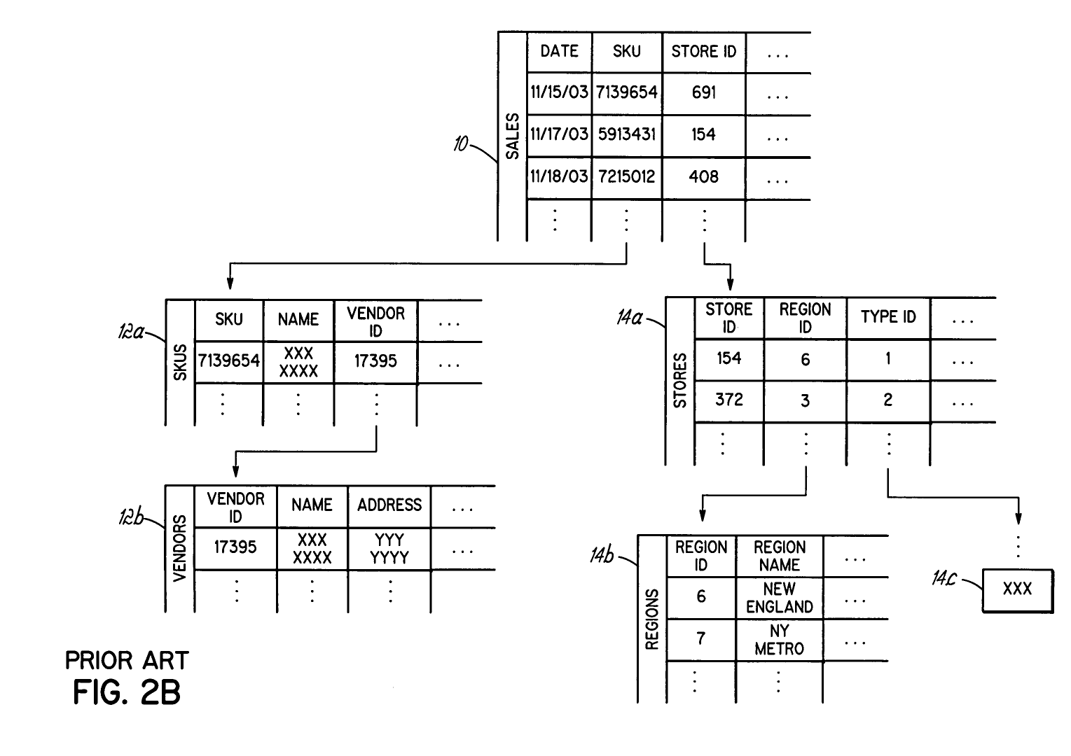

For the purposes of example, consider a query in an SQL-like language, operative upon the “snowflake” schema database of FIG. 2B:

SELECT *

FROM Sales, Stores, Regions

WHERE

Sales.StoreID = Stores.StoreID and
Stores.RegionID = Regions.RegionID and
Store.TypeID = ″1″ and
Regions.RegionlID = ″New England″

Summarizing this query, it seeks a table of all sales at retail stores (Store type 1) in New England.

Applying the process described above, the tables Sales, Stores and Regions are initially considered. The potential join between Sales and Regions is a cartesian product join, and is eliminated. The potential join between Sales and Stores is evaluated, but the selection criterion Stores.TypeID=“1” is found to be of limited reductive effect, for the reason that most sales are made at retail stores, and so this join is rejected. The potential join between Stores as a first table and Regions as a second table, is found to be beneficial, for the reason that few stores are in New England. As a consequence, query processing is reformed to utilize a look-ahead predicate generated from the results of selecting those tuples in the “New England” region in the Regions table (which may, in the stated example, be a single tuple). This look-ahead predicate, which for referential ease will be called Regions', is then substituted for the Regions table in the next pass through the analysis. Written in SQL, the query would now be

WITH Regions' as
(SELECT *

FROM Regions
WHERE Regions.Name = ″New England″)

SELECT *

FROM Sales, Stores, Regions'

WHERE

Sales.StoreID = Stores.StoreID and
Stores.RegionID = Regions'.RegionID and
Stores.TypeID = ″1″ and
Stores.RegionID IN LIST (Regions'.RegionID)

(The syntax of IN LIST in this SQL-like language, refers to the star-join use of a look-ahead predicate, which is a hybrid between the SQL IN list and an IN subquery.)

In the second pass through the process, the join combinations of Sales, Stores and Regions' are evaluated. Regions' and Sales is a cartesian product join, and so is not beneficially reductive. The combination of Regions' as a first table with Stores as a second table subject to the Stores.TypeID=“1” criterion, is not beneficially reductive, because Regions' already has been substantially reduced in size. However, the join combination of Sales as a first table and Stores as a second table, which was previously not beneficially reductive, is now beneficially reductive, due to the new look-ahead predicate Stores.RegionID IN LIST (Regions'.RegionID), which is substantially selective of the tuples of Stores (there are only a few stores in New England).

Hence, at the conclusion of the second pass, query processing is again reformed to utilize a second look-ahead predicate, generated from the first look-ahead predicate and the Stores table, the second look-ahead predicate selecting only those Stores in the “New England” region. This look-ahead predicate, which for referential ease will be called Stores', is then substituted for the Regions table in the next pass through the analysis. Written in SQL-like language, the query would now be

```
WITH Regions' as
(SELECT *
    FROM Regions
    WHERE Regions.Name = “New England”),
Stores' as
(SELECT *
    FROM Stores
    WHERE
        Stores.TypeID = “1” and
        Stores.RegionID IN LIST (Regions'.RegionID))
SELECT *
    FROM Sales, Stores', Regions'
    WHERE
        Sales.StoreID IN LIST (Stores'.StoreID) and
        Sales.StoreID = Stores'.StoreID
        Stores'.RegionID = Regions'.RegionID
```

As can be seen, the iterative process described, successfully identified a proper ordering for join and selection operation for greatest efficiency in responding to the original query: first a look-ahead predicate is formed listing all regionID's (only one) that is for the New England region. Then a second look-ahead predicate is formed for all retail stores having that region ID. Finally, all sales identifying the StoreID of a store in the second look-ahead predicate, are reported.

The invention in its broader aspects is not limited to the specific details, representative apparatus and method, and illustrative example shown and described. For example, while the invention has been explained in connection with its application to a “snowflake” or star schema database, the invention is readily applicable to evaluation of any query involving joins of tables using selection criteria. Accordingly, departures may be made from such details without departing from the spirit or scope of applicant's general inventive concept.

1. A method of performing a query in a relational database system by operating upon a plurality of relations each comprising a plurality of tuples formed over a plurality of attributes, comprising:
evaluating join predicates in said query to determine whether a join involving a first relation and a second relation will be reductive of said first relation, and if so, performing said query by the prior application of a look-ahead predicate based upon the second relation in the join.

2. The method of claim 1 further comprising determining whether said second relation involved in the join is subject to a selection criterion, and evaluating whether that selection criterion effects a join reduction.

3. The method of claim 2 wherein an amount of join reduction effected by a selection criterion is determined by identifying whether the number of rows in the join result will be smaller than the number of rows in the first relation.

4. The method of claim 2 wherein, upon identifying a join reduction involving a first and a second relation, and a selection criterion on the second relation, the potential benefit of that join reduction is assessed.

5. The method of claim 4 further comprising evaluating the computational expense of generating a look-ahead predicate comprising the tuples of the second relation matching the selection criterion, and comparing said expense to computational savings that result from the join reduction.

6. The method of claim 5 further comprising, upon identifying a beneficial look-ahead predicate, processing the query by forming and utilizing the look-ahead predicate as a selection criterion on the second relations.

7. The method of claim 5 further comprising identifying the most beneficial look-ahead predicate among all potential joins of relations in said query, through iterative analysis of all possible joins.

8. The method of claim 7 further comprising iteratively analyzing all possible joins of the remaining relations and the look-ahead predicate to locate further beneficial look-ahead predicates.

9. Apparatus for performing a query in a relational database system by operating upon a plurality of relations each comprising a plurality of tuples formed over a plurality of attributes, comprising:
a data storage device storing said relations, and
a processor evaluating join predicates in said query to determine whether a join involving a first relation and a second relation will be reductive of said first relation, and if so, performing said query by the prior application of a look-ahead predicate based upon the second relation in the join.

10. The apparatus of claim 9 wherein said processor determines whether a relation involved in the join is subject to a selection criterion, and evaluates whether that selection criterion effects a join reduction.

11. The apparatus of claim 10 wherein an amount of join reduction effected by a selection criterion is determined by identifying whether the number of rows in the join result will be smaller than the number of rows in the first relation.

12. The apparatus of claim 10 wherein, upon identifying a join reduction involving a first and a second relation, and a selection criterion on the second relation, said processor assesses the potential benefit of that join reduction.

13. The apparatus of claim 12 wherein said processor evaluates the computational expense of generating a look-ahead predicate comprising the tuples of the second relation matching the selection criterion, and comparing said expense to computational savings that result from the join reduction.

14. The apparatus of claim 13 wherein, upon identifying a beneficial look-ahead predicate, said processor processes the query by forming and utilizing the look-ahead predicate as a selection criterion on the second relations.

15. The apparatus of claim 13 wherein said processor identifies the most beneficial look-ahead predicate among all potential joins of relations in said query, through iterative analysis of all possible joins.

16. The apparatus of claim 15 wherein said processor iteratively analyzes all possible joins of the remaining relations and the look-ahead predicate to locate further beneficial look-ahead predicates.

17. A program product comprising:
a relational database comprising one or more relations, each relation comprising one or more tuples on one or more attributes, and
relational database system adapted to perform a query on said relational database by evaluating join predicates in said query to determine whether a join involving a first relation and a second relation will be reductive of said first relation, and if so, perform said query by the prior application of a look-ahead predicate based upon the second relation in the join, and
signal bearing media bearing the relational database and the relational database system.

18. The program product of claim 17 wherein the signal bearing media comprises transmission media.

19. The program product of claim 17 wherein the signal bearing media comprises recordable media.
